(19) United States
(12) Patent Application Publication
(10) Pub. No.: US 2015/0185580 A1
(43) Pub. Date: Jul. 2, 2015

(54) ELECTROCHROMIC DEVICE AND METHOD OF MANUFACTURING THE SAME

(71) Applicant: Electronics and Telecommunications Research Institute, Daejeon (KR)

(72) Inventors: Seong-Mok CHO, Daejeon (KR); Tae-Youb KIM, Seoul (KR); Chil Seong AH, Daejeon (KR); Hojun RYU, Seoul (KR)

(21) Appl. No.: 14/295,804

(22) Filed: Jun. 4, 2014

(30) Foreign Application Priority Data
Dec. 27, 2013 (KR) 10-2013-0165354

(51) Int. Cl. G02F 1/153; G02F 1/1347; G02F 1/155

(52) U.S. Cl. CPC G02F 1/153; G02F 1/155; G02F 1/1347

(57) ABSTRACT

Provided is an electrochromic device. The electrochromic device includes a lower substrate; a lower electrode on the lower substrate; a lower electrochromic layer arranged on the lower electrode, wherein the lower electrochromic layer includes first nano particles, electrochromic molecules, and second nano particles, the electrochromic molecules are provided on each of the first nano particles, the second nano particles have an aspect ratio larger than and electrical conductivity higher than the first nano particles; electrolyte provided on the lower electrochromic layer; and an upper electrode on the electrolyte.

### CROSS-REFERENCE TO RELATED APPLICATIONS

This U.S. non-provisional patent application claims priority under 35 U.S.C. §119 of Korean Patent Application No. 10-2013-0165354, filed on Dec. 27, 2013, the entire contents of which are hereby incorporated by reference.

### BACKGROUND OF THE INVENTION

The present invention disclosed herein relates to an electrochromic device, and more particularly, to an electrochromic layer of an electrochromic device and a method of manufacturing the same.

Liquid crystal displays (LCDs) and organic light-emitting diodes (OLEDs) are being widely used as information displays. These devices implement colors by transmitting lights emitting from their light sources through color filters or by combining lights emitting from materials according to the flows of currents.

Recently, electrochromic devices are being applied to optical shutters, reflective displays, electrochromic mirrors for cars, and smart windows. The electrochromic devices cause changes in color by electrochemical reaction. If potential differences occur in the electrochromic devices due to external electrical impulses, ions or electrons included in electrolyte move to the inside or outside of electrochromic layers and cause anodic and cathodic reactions. By the anodic and cathodic reactions of the electrochromic layer, the colors of the electrochromic devices change. Cathodic color change materials mean ones that are colored when cathodic reactions take place and are decolored when anodic reactions take place. Anodic color change materials mean ones that are colored when there are anodic reactions and are decolored when there are cathodic reactions. When the colors of the electrochromic devices change, ion diffusion from electrolyte to the electrochromic layers is needed. Thus, there is a limitation in that the electrochromic speeds of the electrochromic devices are decreased.

### SUMMARY OF THE INVENTION

The present invention provides an electrochromic device having an enhanced electrochromic speed and a method of manufacturing the same.

The present invention also provides an electrochromic device that has enhanced electrical conductivity and ion conductance.

The technical tasks of the present invention are not limited to the above-mentioned technical tasks and other technical tasks not mentioned will be able to be clearly understood by a person skilled in the art from the following descriptions.

Embodiments of the present invention provide, electrochromic devices include a lower substrate; a lower electrode on the lower substrate; a lower electrochromic layer arranged on the lower electrode, wherein the lower electrochromic layer includes first nano particles, electrochromic molecules, and second nano particles, the electrochromic molecules are provided on each of the first nano particles, the second nano particles have an aspect ratio larger than and electrical conductivity higher than the first nano particles; electrolyte provided on the lower electrochromic layer; and an upper electrode on the electrolyte.

In some embodiments, the electrolyte may be extended to between the first nano particles of the lower electrochromic layer and is in contact with the electrochromic molecules. In other embodiments, a total volume the second nano particles in the mixture may be 0.001% to 10% of a total volume the first nano particles in the mixture.

In still other embodiments, the second nano particles may be in contact with the first nano particles or the electrochromic molecules.

In even other embodiments, the lower electrochromic layer may be transparent.

In yet other embodiments, the second nano particles may include a metal.

In further embodiments, the electrochromic devices may further including an upper electrochromic layer between the electrolyte and the upper electrode, wherein the upper electrochromic layer includes first upper nano particles; upper electrochromic molecules anchored onto the first upper nano particles; and second upper nano particles having an aspect ratio larger than and electrical conductivity higher than the first upper nano particles.

In other embodiments of the present invention, methods of manufacturing an electrochromic device include arranging a lower electrode on a substrate; providing a mixture including first nano particles, second nano particles, and a polymer, wherein the second nano particles have an aspect ratio larger than and electrical conductivity higher than the first nano particles; applying the mixture onto the lower electrode to manufacture a precursor film; adding electrochromic molecules to the precursor film to form an electrochromic layer, wherein the electrochromic molecules are anchored onto each of the first nano particles of the electrochromic layer; forming electrolyte on the lower electrochromic layer; and forming an upper electrode on the electrolyte.

In some embodiments, the methods may further include thermally treating the precursor film to connect the first nano particles with each other.

In other embodiments, the polymer may be provided to between the first nano particles of the mixture, thermal treatment of the precursor film may be performed at a temperature over the thermal decomposition of the polymer, and pores may be formed between the first nano particles by the thermal treatment of the precursor film.

In still other embodiments, the electrolyte may be extended to between the first nano particles of the electrochromic layer and be in contact with the electrochromic molecules of the electrochromic layer.

In even other embodiments, the second nano particles may include a nanotube, a nanorod, and a nanowire.

In other embodiments of the present invention, methods of manufacturing an electrochromic device include arranging a lower electrode on a substrate; providing a mixture including first nano particles, second nano particles, and electrochromic molecules, wherein the second nano particles have an aspect ratio larger than and electrical conductivity higher than the first nano particles, and the electrochromic molecules are provided onto each of the first nano particles; applying the mixture onto the lower electrode to form an electrochromic layer; forming electrolyte, wherein the electrolyte is provided onto the electrochromic layer and is extended to between the first nano particles of the electrochromic layer; and forming an upper electrode on the electrolyte.

In some embodiments, the methods may further include thermally treating the electrochromic layer at a temperature of 80° C. to 200° C. to connect the first nano particles with each other.

In other embodiments, the electrolyte may be extended to between the first nano particles of the electrochromic layer and is in contact with the electrochromic molecules.

In still other embodiments, the second nano particles may be 0.001 vol % to 10 vol % of the first nano particles.

In even other embodiments, the second nano particles may include a metal and the electrochromic layer is transparent.

In yet other embodiments, the method may further include forming an upper electrochromic layer between the electrolyte and the upper electrode.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a cross-sectional view of an electrochromic device according to an embodiment of the present invention;

FIG. 2 is an enlarged view of a circled part “II” of FIG. 1;

FIG. 3 is a cross-sectional view of an electrochromic device according to another embodiment of the present invention;

FIGS. 4 and 5 are cross-sectional views of a method of manufacturing an electrode for an electrochromic device according to an embodiment of the present invention; and

FIGS. 6 and 7 are cross-sectional views of a method of manufacturing an electrode for an electrochromic device according to another embodiment of the present invention.

### DETAILED DESCRIPTION OF PREFERRED EMBODIMENTS

For the readers to sufficiently understand the configuration and effect of the present invention, exemplary embodiments of the present invention are described with reference to the accompanying drawings. The present invention may, however, be embodied in different forms and should not be construed as limited to the embodiments set forth herein. The embodiments are provided to make the disclosure of the present invention complete and completely inform a person skilled in the art of the scope of the present invention. A person skilled in the art will be able to understand that the concepts of the present invention may be performed in any suitable environments.

The terms used herein are only for explaining embodiments while not limiting the present invention. The terms of a singular form may include plural forms unless referred to the contrary. The terms used herein “includes”, “comprises”, “including” and/or “comprising” do not exclude the presence or addition of one or more components, steps, operations and/or elements other than the components, steps, operations and/or elements that are mentioned.

In the specification, when a film (or layer) is referred to as being ‘on’ another film (or layer) or substrate, it can be directly on the other film (or layer) or substrate, or a third film (or layer) may also be present therebetween.

Though terms like a first, a second, and a third are used to describe various regions and films (or layers) in various embodiments of the present invention, the regions and the films are not limited to these terms. These terms are used only to distinguish a certain region or film (or layer) from another region or film (or layer). Thus, a film referred to as a first film in an embodiment may also be referred to as a second film in another embodiment. Each embodiment described and illustrated herein includes its complementary embodiment. The same reference numerals represent the same components throughout the disclosure.

Terms used in embodiments of the present invention may be construed as meanings known typically to a person skilled in the art unless being defined otherwise.

Exemplary embodiments of the present invention are described below in detail with reference to the accompanying drawings.

An electrochromic device according to the concepts of the present invention is described below.

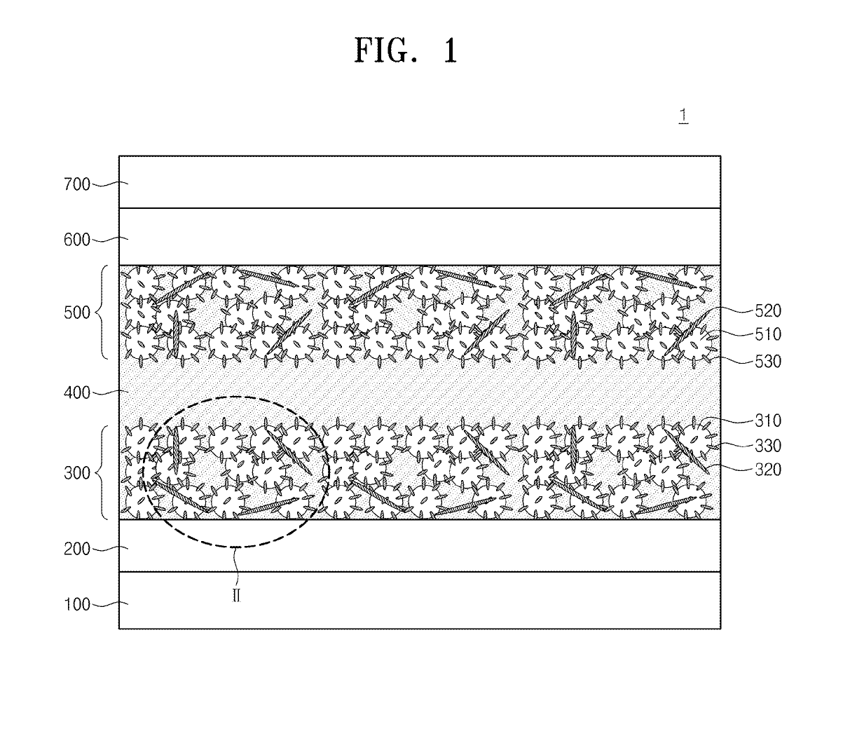

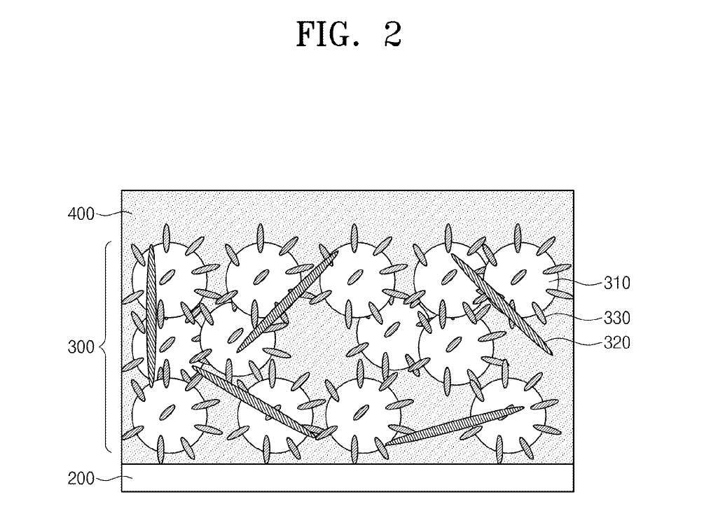

FIG. 1 is a cross-sectional view of an electrochromic device according to an embodiment of the present invention. FIG. 2 is an enlarged view of a circled part “II” of FIG. 1.

Referring to FIGS. 1 to 2, an electrochromic device 1 according to the present invention may include a lower substrate 100, a lower electrode 200, a lower electrochromic layer 300, electrolyte 400, an upper electrochromic layer 500, an upper electrode 600, and an upper substrate 700. The electrochromic device 1 of the present invention may be transparent.

The lower substrate 100 may be a transparent substrate. For example, the lower substrate may include any one of glass, plastic and transparent conductive substrates. The lower electrode 200 may be provided on a substrate.

The lower electrode 200 may include transparent conductive oxide (TCO).

The lower electrochromic layer 300 may be provided on the lower electrode 200. The lower electrochromic layer 300 may include first nano particles 310, second nano particles 320, and electrochromic molecules 330. The first nano particles 310 may include semiconductor or transparent, conductive oxide such as TiO₂.

As an example, the first nano particles 310 may have a globular shape. The first nano particles 310 may be connected with each other. Thus, the mechanical strength of the lower electrochromic layer 300 may be enhanced. Also, electrons provided from the lower electrode 200 may be transported to the electrochromic molecules 330 through the first nano particles 310.

As the first nano particles 310 are coupled to one another, electrical conductivity in the lower electrochromic layer 300 may be enhanced.

The electrochromic molecules 330 may be provided on each of the first nano particles 310. The electrochromic molecules 330 may be anchored to the surfaces of the first nano particles 310. The electrochromic molecules 330 may include cathodic electrochromic molecules, e.g., viologen. The second nano particles 320 may be in contact with the first nano particles 310 or the electrochromic molecules 330. The second nano particles 320 may have an aspect ratio larger than the first nano particles 310. In this example, the aspect ratio may mean a value obtained by dividing the longest axis of a particle by its shortest axis. As an example, the second nano particles 320 may be nano wires, nano rods or nano tubes. As the aspect ratio of each of the second nano particles 320 increases, the electrical conductivity of each of the second nano particles may increase. Since the lower electrochromic layer 300 includes the second nano particles 320, the electron transport between the lower electrode 200 and the electrochromic molecules 330 may be smoother. The second nano particles 320 may include any one of a metal such as zinc (Zn), tungsten (W), aluminum (Al), silver (Ag), platinum (Au), nickel (Ni), and a combination thereof. The second nano particles 320 may be opaque. The lower electrochromic layer 300 of the present invention may be transparent. The lower electrochromic layer 300 may include the second nano particles 320 that are 0.001 vol % to 10 vol % of the first nano particles 310. When the second nano particles 320 exceed 10 vol % of the first nano particles 310 in the lower electrochromic layer 300, the transparency of the lower electrochromic layer 300 may decrease. The second nano particles 320 of the present invention may be uniformly distributed and provided in the lower electrochromic layer 300. For example, the density of the second nano particles 320 at the lower part of the lower electrochromic layer 300 may be the same or similar as that of the second nano particles 320 at the upper part of the lower electrochromic layer 300. The second nano particles 320 may be spaced apart from one another. Thus, the second nano particles 320 may not affect the transparency of the lower electrochromic layer 300.

The electrolyte 400 may be provided on the lower electrochromic layer 300. The electrolyte 400 may be in a liquid or gel state. The electrolyte 400 may play a role of transporting ion between the lower electrochromic layer 300 and the upper electrochromic layer 500. The electrolyte 400 is extended to the lower electrochromic layer 300 and may be filled between the first nano particles 310 of the lower electrochromic layer 300. The electrolyte 400 may be in direct contact with the electrochromic molecules 330. When the colors of the electrochromic molecules 330 change, the travel distance of ions that move between the electrochromic molecules 330 and the electrolyte 400 may decrease. Thus, the electrochromic speed of the electrochromic device 1 may be enhanced.

The upper electrochromic layer 500 may be provided on the electrolyte 400. The upper electrochromic layer 500 may include first upper nano particles 510, second upper nano particles 520, and upper electrochromic molecules 530. The first upper nano particles 510 and the second upper nano particles 520 may be the same or similar respectively to the first nano particles 310, the second nano particles 320, and the electrochromic molecules 330 that are above-described. For example, the upper electrochromic molecules 530 may be provided on the surface of each of the first upper nano particles 510. The upper electrochromic molecules 530 may include a cathodic color change material such as NiOH₂, Ir(OH)ₓ, and/or CO₂. The electrolyte 400 may be extended to between the first upper nano particles 510 of the upper electrochromic layer 500. The electrolyte 400 may be in contact with the upper electrochromic molecules 530. The second upper nano particles 520 may have an aspect ratio larger than the first upper nano particles 510. The second upper nano particles 520 may be uniformly distributed and provided in the upper electrochromic layer 500. For example, the second upper nano particles 520 may have the shapes of nano rods, nano wires or nano tubes. As the upper electrochromic layer 500 includes the second upper nano particles 520, the electrical conductivity of the upper electrochromic layer 500 may be further enhanced. However, the upper electrochromic layer 500 may not include first upper nano particles 510 and the second upper nano particles 520.

An upper electrode 600 and an upper substrate 700 may be sequentially stacked on the upper electrochromic layer 500. The upper electrode 600 may include TCO. The upper substrate 700 may be a glass substrate.

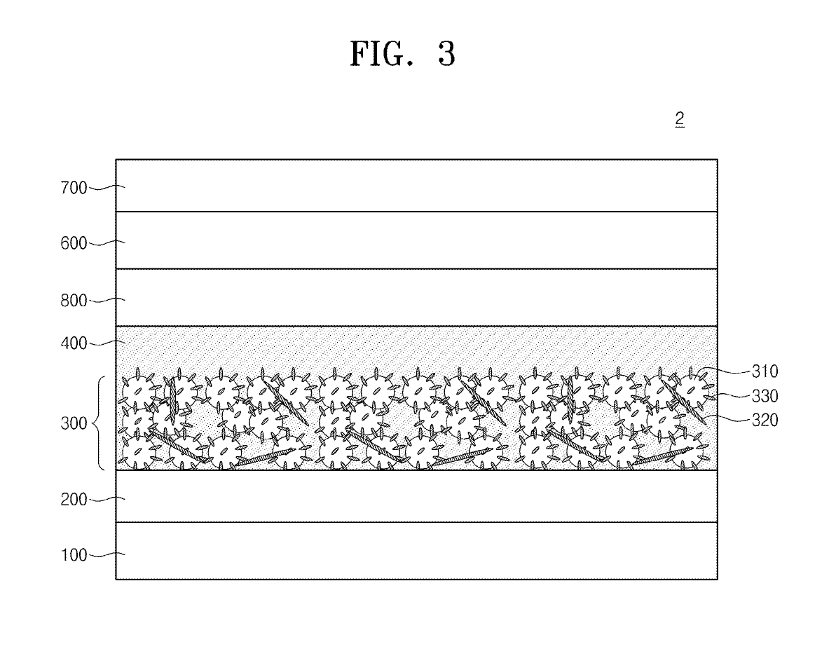

FIG. 3 is a cross-sectional view of an electrochromic device according to another embodiment of the present invention. What is described above is left out below.

Referring to FIG. 3 along with FIG. 2, the electrochromic device 2 may be transparent. The electrochromic device 2 may include the lower substrate 100, the lower electrode 200, the lower electrochromic layer 300, the electrolyte 400, an ion storage layer 800, the upper electrode 600, and the upper substrate 700. The lower substrate 100, the lower electrode 200, the lower electrochromic layer 300, the electrolyte 400, and the upper electrode 600 may be the same of similar as those described above.

For example, the lower electrochromic layer 300 may include the first nano particles 310, the second nano particles 320, and the electrochromic molecules 330. The electrochromic molecules 330 may include cathodic electrochromic molecules, e.g., viologen.

The electrolyte 400 may be provided on the lower electrochromic layer 300. The electrolyte 400 may be filled between the first nano particles 310 of the lower electrochromic layer 300. The electrolyte 400 may be in direct contact with the electrochromic molecules 330.

The ion storage layer 800 may include CeO₂ and/or TiO₂. The ion storage layer 800 may store ions under electrochromic coloration and decoloration (e.g., hydrogen ions or lithium ions).

A method of manufacturing an electrochromic device according to embodiments of the present invention is described below.

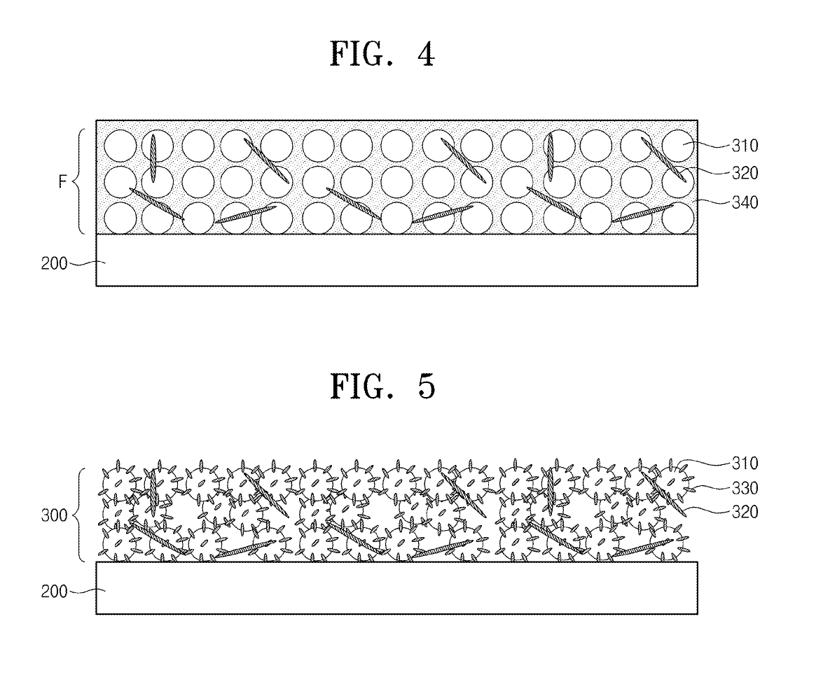

FIGS. 4 and 5 are cross-sectional views of a method of manufacturing an electrode for an electrochromic device according to an embodiment of the present invention. What is described above is left out below.

Referring to FIG. 4, a mixture including the first nano particles 310, the second nano particles 320, and a polymer 340 may be provided. The polymer 340 may fill the spaces between the first nano particles 310. The second nano particles 320 may occupy 0.001 vol % to 10 vol % of the first nano particles 310 in the mixture. The lower electrode 200 is coated with the mixture and thus a precursor film F may be formed on one surface of the lower electrode 200. The lower electrode 200 may be the lower electrode 200 that is described in FIG. 1.

Referring to FIG. 5, the precursor film (F of FIG. 4) is thermally treated and thus the lower electrochromic layer 300 may be formed on the lower electrode 200. The lower electrochromic layer 300 may be the same or similar as that described above as an example of FIGS. 1 and 2. By the thermal treatment of the precursor film F, the first nano particles 310 may be coupled to one another. Thus, the contact between the first nano particles 310 may be enhanced. The thermal treatment of the precursor film F may be performed at a temperature over the thermal decomposition temperature of the polymer 340. For example, the precursor film F may be thermally treated at a temperature of 120° C. to 500° C. The polymer 340 included in the precursor film F may be removed by thermal treatment. Thus, there may be pores between the first nano particles 310.

The electrochromic molecules 330 may be anchored to the first nano particles 310 of the precursor film F. The electrochromic molecules 330 may be provided on the precursor film F. The electrochromic molecules 330 may include the cathodic electrochromic molecules 330, e.g., viologen. For example, the electrochromic molecules 300 may be added to solvent (e.g., ethanol) and electrochromic solution may thus be formed. In this case, each of the electrochromic molecules 330 may be bound to one end of a functional group. As an example, the functional group may be phosphate. The precursor film F may be added to the electrochromic solution. The other end of the functional group bound to each of the electrochromic particles 330 may be bound to each of the first nano particles 310. Thus, the electrochromic molecules 330 may be anchored to the surfaces of the first nano particles 310. The electrochromic molecules 330 may be electrically connected to the first nano particles 310. Thus, manufacturing the lower electrochromic layer 300 described as an example of FIG. 1 may be completed.

Referring back to FIG. 1, the upper electrochromic layer 500 and the upper electrode may be formed on the lower electrochromic layer 300. The upper electrochromic layer 500 may be manufactured by using the same or similar method as an example of manufacturing the lower electrochromic layer 300 previously described as an example of FIG. 4 and. However, the upper electrochromic molecules 530 may include a cathodic color change material. The electrolyte 400 may be formed between the lower electrochromic layer 300 and the upper electrochromic layer 500. For example, the electrolyte 400 may be in a liquid state. The lower electrochromic layer 300 may be arranged to face the upper electrochromic layer 500 at an interval. A liquid electrolyte material is injected between the lower electrochromic layer 300 and the upper electrochromic layer 500, and the electrolyte may thus be formed. In this case, the electrolyte 400 may be filled between the first nano particles 310 of the lower electrochromic layer 300. The electrolyte 400 may be in contact with the electrochromic molecules 330. The electrolyte 400 may be filled between the first upper nano particles 510 of the upper electrochromic layer 500. The lower substrate 100 may be formed at the bottom of the lower electrode 200. As an example, after the process of forming the electrolyte 400, the lower substrate 100 may be formed. As another example, before forming the precursor film F described as an example of FIG. 4, the lower substrate 100 may be formed on the other surface of the lower electrode 200. The upper substrate 700 may be arranged on the upper electrode 600. However, the ion storage layer 800, the upper electrode 600, and the upper substrate 700 may be arranged on the electrolyte 400 so that the electrochromic device 2 as shown in FIG. 2 may be manufactured. The order of forming the lower substrate 100, the lower electrode 200, the upper electrode 600, and the upper substrate 700 may vary.

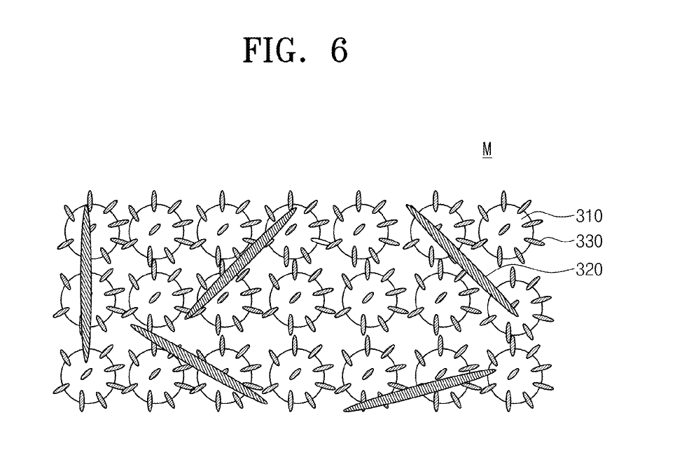

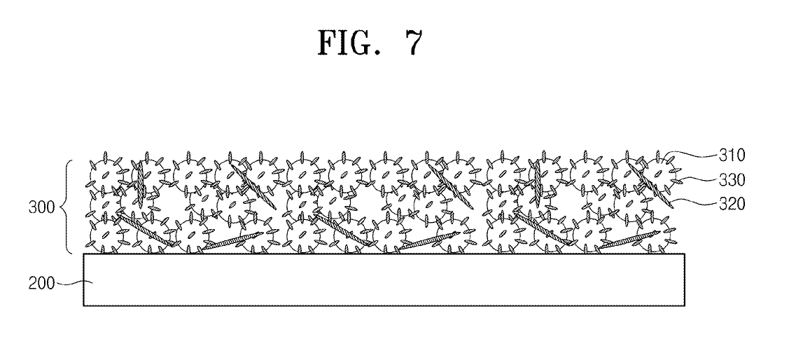

FIGS. 6 and 7 are cross-sectional views of a method of manufacturing an electrochromic device according to another embodiment of the present invention. What is described above is left out below.

Referring to FIG. 6, a mixture M that includes the first nano particles 310, the second nano particles 320, and the electrochromic molecules 330 may be provided. For example, a precursor including the first nano particles 310 and the electrochromic molecules 330 may be manufactured. The electrochromic molecules 330 may be anchored to the surfaces of the first nano particles 310. In this example, the polymer described in FIG. 4 may not be included. The second nano particles 320 may be added to the precursor and the mixture may thus be manufactured. The second nano particles 320 may occupy 0.001 vol % to 10 vol % of the first nano particles 310. The second nano particles 320 may have an aspect ratio larger than the first nano particles 310. The second nano particles 320 may have electrical conductivity higher than the first nano particles 310. The second nano particles 320 may include the same or similar materials as that previously described as an example of FIGS. 1 and 2. A manufactured mixture M may be in a slurry state.

Referring to FIG. 7, the mixture M (of FIG. 7) is applied onto the lower electrode 200 so that the lower electrochromic layer 300 may be manufactured. The lower electrode 200 may be the lower electrode 200 that is previously described as an example of FIG. 1. For example, the mixture M is applied onto the lower electrode 200 so that a precursor layer (not shown) may be formed. The precursor layer (not shown) is thermally treated at a temperature of 80° C. to 200° C. so that the electrochromic layer 300 may be formed. Under such a temperature condition, the lower substrate 100 and the lower electrochromic layer 300 may not be damaged due to heat. The first nano particles 310 may be connected with each other by the thermal treatment.

Referring back to FIG. 1, the electrolyte 400, the upper electrode 600, and the upper substrate 700 may be arranged on the lower electrochromic layer 300. The upper electrochromic layer 500 may be manufactured by using the same or similar method as an example of manufacturing the lower electrochromic layer 300 previously described in FIGS. 4 and 5 or in FIGS. 6 and 7. However, the upper electrochromic molecules 530 may include a cathodic color change material. The order of forming the lower substrate 100, the electrolyte 400, the upper electrode 400 and the upper substrate 700 may be the same or similar as that previously described. However, the ion storage layer 800, the upper electrode 600, and the upper substrate 700 are arranged on the electrolyte 400 so that the electrochromic device 2 as shown in FIG. 2 may be manufactured.

The second nano particles according to the present invention may have an aspect ratio larger than the first nano particles and electrical conductivity higher than the first nano particles. As the electrochromic layer includes the second nano particles, the electrical conductivity and electrochromic speed of the electrochromic layer may be enhanced. The electrochromic layer may be transparent. The second nano particles may be uniformly distributed and provided in the electrochromic layer. Thus, the second nano particles may not affect the transparency of the electrochromic layer. The electrochromic molecules may be provided on the first nano particles. The electrolyte may be in direct contact with the electrochromic molecules. Thus, the electrochromic speed of the electrochromic device may be more enhanced.

According to an embodiment, the lower electrochromic layer may not be damaged by the thermal treatment.

What is claimed is:

1. An electrochromic device comprising:
a lower substrate;
a lower electrode on the lower substrate;
a lower electrochromic layer disposed on the lower electrode, wherein the lower electrochromic layer comprises first nano particles, electrochromic molecules, and second nano particles, the electrochromic molecules are provided on each of the first nano particles, the second nano particles have an aspect ratio larger than and electrical conductivity higher than the first nano particles;
electrolyte provided on the lower electrochromic layer; and
an upper electrode on the electrolyte.

2. The electrochromic device of claim 1, wherein the electrolyte is extended to between the first nano particles of the lower electrochromic layer and is in contact with the electrochromic molecules.

3. The electrochromic device of claim 1, wherein a total volume of the second nano particles are 0.001% to 10% of a total volume of the first nano particles in the lower electrochromic layer.

4. The electrochromic device of claim 1, wherein the second nano particles are in contact with the first nano particles or the electrochromic molecules.

5. The electrochromic device of claim 1, wherein the lower electrochromic layer is transparent.

6. The electrochromic device of claim 1, wherein the second nano particles comprise a metal.

7. The electrochromic device of claim 1, further comprising an upper electrochromic layer between the electrolyte and the upper electrode,
wherein the upper electrochromic layer comprises first upper nano particles; upper electrochromic molecules anchored onto the first upper nano particles; and second upper nano particles having an aspect ratio larger than and electrical conductivity higher than the first upper nano particles.

8. A method of manufacturing an electrochromic device, the method comprising:
disposing a lower electrode on a substrate;
providing a mixture comprising first nano particles, second nano particles, and a polymer, wherein the second nano particles have an aspect ratio larger than and electrical conductivity higher than the first nano particles;
applying the mixture onto the lower electrode to manufacture a precursor film;
adding electrochromic molecules to the precursor film to form an electrochromic layer, wherein the electrochromic molecules are anchored onto each of the first nano particles of the electrochromic layer;
forming electrolyte on the lower electrochromic layer; and
forming an upper electrode on the electrolyte.

9. The method of claim 8, further comprising thermally treating the precursor film to connect the first nano particles with each other.

10. The method of claim 9, wherein the polymer is provided to between the first nano particles of the mixture,
thermal treatment of the precursor film is performed at a temperature over the thermal decomposition of the polymer, and
pores are formed between the first nano particles by the thermal treatment of the precursor film.

11. The method of claim 8, wherein the electrolyte is extended to between the first nano particles of the electrochromic layer and is in contact with the electrochromic molecules of the electrochromic layer.

12. The method of claim 8, wherein the second nano particles comprise a nanotube, a nanorod, and a nanowire.

13. A method of manufacturing an electrochromic device, the method comprising:
disposing a lower electrode on a substrate;
providing a mixture comprising first nano particles, second nano particles, and electrochromic molecules, wherein the second nano particles have an aspect ratio larger than and electrical conductivity higher than the first nano particles, and the electrochromic molecules are provided onto each of the first nano particles;
applying the mixture onto the lower electrode to form an electrochromic layer;
forming electrolyte on the electrochromic layer, wherein the electrolyte is extended to between the first nano particles of the electrochromic layer; and
forming an upper electrode on the electrolyte.

14. The method of claim 13, further comprising thermally treating the electrochromic layer at a temperature of 80° C. to 200° C. to connect the first nano particles with each other.

15. The method of claim 13, wherein the electrolyte is in contact with the electrochromic molecules.

16. The method of claim 13, wherein a total volume of the second nano particles in the mixture is 0.001% to 10% of a total volume of the first nano particles in the mixture.

17. The method of claim 13, wherein the second nano particles comprise a metal and the electrochromic layer is transparent.

18. The method of claim 13, further comprising forming an upper electrochromic layer between the electrolyte and the upper electrode.
